(19) United States
(12) Patent Application Publication
(10) Pub. No.: US 2020/0045988 A1
(43) Pub. Date: Feb. 13, 2020

(54) ENERGY EFFICIENT EXHAUSTLESS ROASTING APPARATUS AND METHOD

(71) Applicant: Continental Brokers and Consultants Inc., Oklahoma City, OK (US)

(72) Inventors: Daniel D. Jolliff, Oklahoma City, OK (US); Jesse Bowser, Oklahoma City, OK (US)

(21) Appl. No.: 16/533,437

(22) Filed: Aug. 6, 2019

Related U.S. Application Data
(60) Provisional application No. 62/716,643, filed on Aug. 9, 2018.

(51) Int. Cl. A23F 5/04; F01N 3/035; F23G 7/07

(52) U.S. Cl. CPC A23F 5/04; F23G 7/07; F01N 3/035

(57) ABSTRACT

Invention includes an energy efficient exhaustless and smokeless roasting apparatus and method that is adapted for roasting products, and, in particular, to an apparatus and method for roasting coffee beans in a manner that eliminates smokes and exhaust and increases energy efficiency while improving the quality of the roasted coffee beans.

### CROSS-REFERENCE TO RELATED APPLICATIONS

Priority is claimed from provisional patent application U.S. Ser. No. 62/716,643 filed on Aug. 9, 2018 and incorporated by reference herein.

### BACKGROUND OF THE INVENTION

### 1. Field of the Invention

This invention relates, in general, to an apparatus and method for roasting products, and, in particular, to an apparatus and method for roasting coffee beans in a manner that eliminates smokes and exhaust and increases energy efficiency while improving the quality of the roasted coffee beans.

### 2. Description of the Known Prior Art

In its simplest form, coffee roasting transforms the chemical and physical properties of green coffee beans into roasted coffee products. The roasting process is what produces the characteristic flavor of coffee by causing the green coffee beans to change in taste. Unroasted beans contain similar if not higher levels of acids, protein, sugars, and caffeine as those that have been roasted, but lack the taste of roasted coffee beans due to the Maillard and other chemical reactions that occur during roasting. This includes heating coffee beans to a prescribed temperature, at which point chemical reactions occur transforming the beans into the characteristic flavor, color and aroma known by consumers. The complex business of coffee roasting, however, requires careful attention to numerous factors, all of which influence the taste and appearance of the product. Such important considerations include temperature of the roaster, residence time at the terminal temperature and economic factors, such as capital costs, energy costs and coffee loss during the roasting process.

The vast majority of coffee is roasted commercially on a large scale, but small-scale commercial roasting has grown significantly with the trend toward “single-origin” coffees served at specialty shops. Some coffee drinkers even roast coffee at home as a hobby in order to both experiment with the flavor profile of the beans and ensure the freshest possible roast. Traditional roasting systems require a large amount of energy and generate a substantial amount of smoke, heat exhaust and chaff in order to produce quality coffee bean roasts. In recent years, a number of methods and apparatus for roasting have been proposed for the purpose of minimizing such pollution while still maintaining an economical process. Despite these and other efforts in the art, there remains a significant need for a new and improved roasting apparatus and method that eliminates smoke and exhaust emissions while maintaining energy efficiency and improving the quality of the roasted coffee beans.

One of the biggest challenges of coffee roasting today is smoke/exhaust abatement and ventilation and primarily affects smaller roasting operations because it requires exhaust vents and significant amounts of space due to the smoke and exhaust emissions that are emitted from existing roaster designs. The coffee roasting process creates a large amount of smoke especially towards the later stage of the roasting process and that smoke/exhaust must be processed as required by the application of state and federal regulations. After heavy particulate has been filtered, traditional roasters require the exhaust air to be passed through an afterburner before being vented out of the building. This makes it difficult for those who cannot easily run a vent line from the roaster location to the outside, and also limits the placement of the roaster within the building. The afterburner itself also causes issues. For example, for an afterburner to work it needs to run at temperatures of around 1200° F., which is extremely hot when compared to the operating temperature of the roaster which is approximately less than 500° F. This is a tremendous source of energy waste since all of the heat is just vented out of the building to the outside environment. Both of these issues together result in unnecessary added costs as well as safety and maintenance concerns.

Thus, there is a need for an apparatus, process and or system in the marketplace for a roaster that is smokeless and exhaustless that can be installed in any space and does not require installation of an exhaust vent running from the roaster to the exterior of the building. The above discussed limitations in the prior art is not exhaustive. The current invention provides an inexpensive, time saving, more reliable apparatus, method and system where the prior art fails.

### BRIEF SUMMARY OF THE INVENTION

In view of the foregoing disadvantages inherent in the known existing apparatuses and methods for roasting coffee beans, the present invention provides a new and improved apparatus and method for roasting coffee beans in a manner that eliminates smoke and exhaust while increasing energy efficiency and improving the quality of the roasted coffee beans. As such, the general purpose of the present invention, which will be described subsequently in greater detail, is to provide a more energy efficient and environmentally friendly coffee roaster and method that has all the advantages of the prior art devices while overcoming the known disadvantages.

To attain this, the present invention essentially comprises a roasting chamber built to maintain large or small amounts of coffee beans, and withstand high temperatures; a catalyst cabinet used to burn smoke such that exhaust emissions are reduced and air can be heated for recirculation into the roaster; and, a control cabinet for supplying power to the system and controlling the operations in a manner that can be monitored by the operator. Furthermore, the present invention uses a low oxygen environment for the roasting process. In a preferred embodiment, the only necessary oxygen introduced into the hot air stream is for maintaining combustion within the catalyst cabinet. Such control of oxygen content retards the exothermic reaction within the coffee beans and reduces the production of acidic gases, resulting in smoother tasting coffee. The degree to which oxygen is introduced is fully controllable by the user to accommodate any variety of coffee bean or depth of roast.

In this respect, before explaining at least one embodiment of the invention in detail, it is to be understood that the invention is not limited in this application to the details of construction and to the arrangement of the components set forth in the following description or illustrated in the drawings. The invention is capable of other embodiments and of being practiced and carried out in various ways. For example, while coffee bean roasting is discussed throughout, it is to be understood that the present invention can be used for a variety of other products, such as nuts, cacao beans, fruits, wood chips and many other organic and non-organic items. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore that the claims be regarded as including such equivalent constructions insofar as they do not depart from the spirit and scope of the present invention.

Accordingly, titles, headings, chapter names, classifications and overall segmentation of the application in general should not be construed as limiting. Such are provided for overall readability and not necessarily as literally defining text or material associated therewith.

It is therefore an object of the present invention to provide an improved coffee roaster and method that minimizes emissions and energy consumption while producing quality coffee bean roasts.

Another further object of the present invention is to provide a new and improved roasting apparatus and method, which is of a relatively simple design and thus may be easily and efficiently manufactured. The roasting system described herein may be small enough to produce coffee beans sufficient for a small cup of coffee, and may alternatively be large enough to produce as many coffee beans necessary for large quantities of coffee.

An even further object of the present invention is to provide a new and improved roasting apparatus and method, which is of a more durable and reliable construction than that of the existing known art.

Still another object to the present invention to provide a new and improved roasting apparatus and method, which is susceptible to a low cost of manufacture with regard to both materials and labor, which accordingly is then susceptible of low prices of sale to the consuming public, thereby making such economically available to those utilizing coffee roasters.

Another object of the present invention is to provide a new and improved roasting apparatus and method that provides some of the advantages of the prior art, while simultaneously overcoming some of the disadvantages normally associated therewith.

It is a further object of the present invention to provide an improved coffee roaster and method that enhances the safety of the prior art during indoor use without sacrificing on efficiency or quality.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference would be had to the accompanying drawings and descriptive matter in which there are illustrated preferred embodiments of the invention.

### BRIEF DESCRIPTION OF THE SEVERAL VIEWS OF THE DRAWING

The invention will be better understood and objects other than those set forth above will become apparent when consideration is given to the following detailed description thereof. Such description makes reference to the annexed pictorial illustrations, graphs, drawings, and appendices.

FIG. 1 is generally a side view of a roasting apparatus constructed in accordance with the present invention.

FIG. 2 is generally a rear view of a roasting apparatus constructed in accordance with the present invention having the airflow indicated thereon.

FIG. 3 is generally a front view of a roasting apparatus constructed in accordance with the present invention.

FIG. 4 is generally a side view of a roasting apparatus constructed in accordance with the present invention having the airflow indicated thereon.

FIG. 5 is generally a front view of a roasting apparatus constructed in accordance with the present invention with the roasting chamber uncovered.

FIG. 6 is generally a perspective view of a roasting apparatus constructed in accordance with the present invention.

FIG. 7 is generally a partially-dissected side views of a roasting apparatus constructed in accordance with the present invention.

FIG. 8 is generally a partially-dissected side views of a roasting apparatus constructed in accordance with the present invention.

FIG. 9 is generally a partially-dissected rear view of a roasting apparatus constructed in accordance with the present invention.

### DETAILED DESCRIPTION OF THE INVENTION

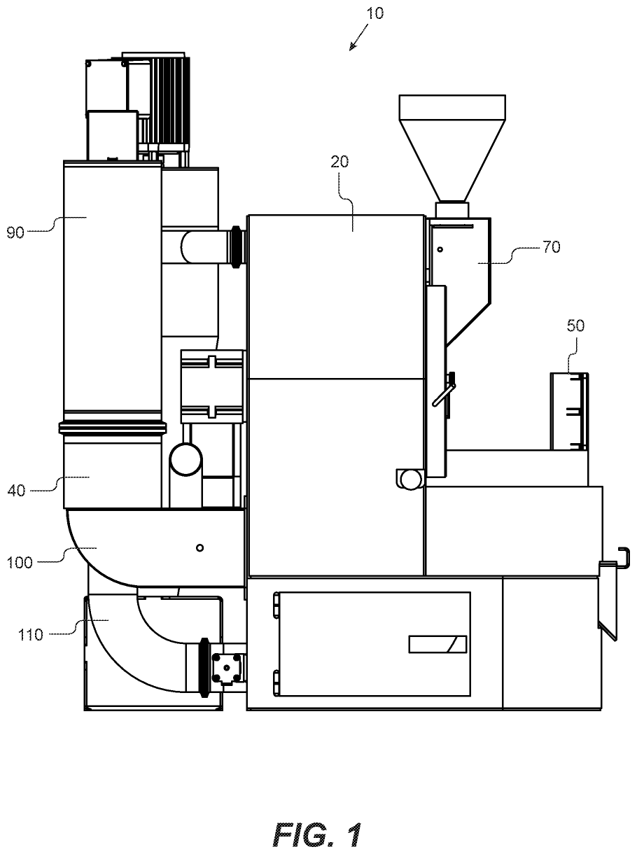

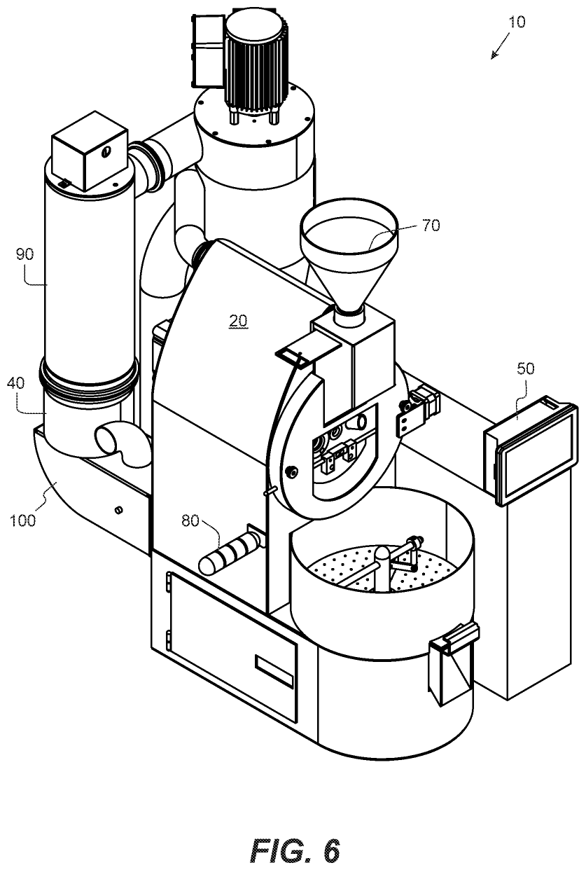

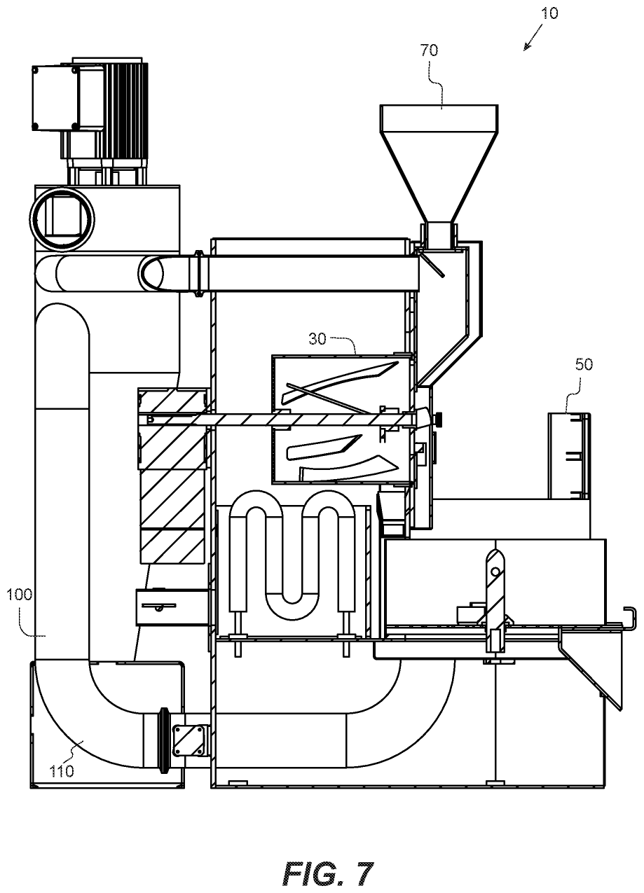

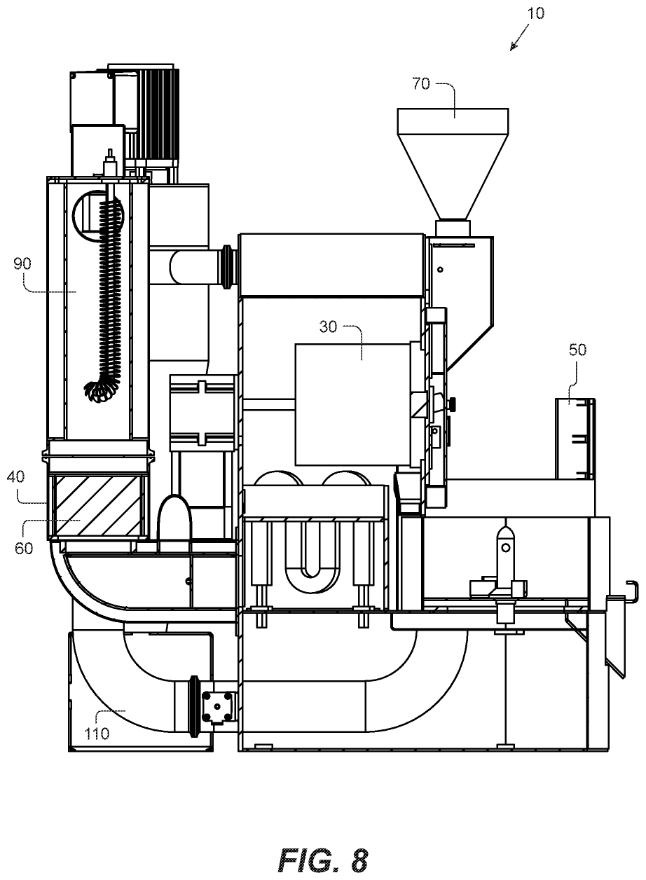

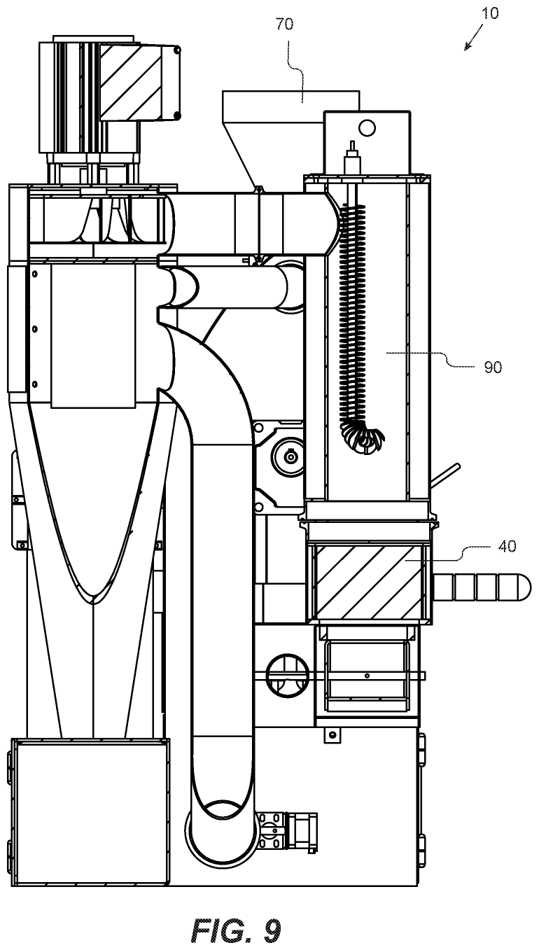

Referring to the drawings, there is illustrated a roasting apparatus 10 embodying the present invention. The roasting apparatus 10 illustrated in FIGS. 1-9 may be constructed to include a roasting chamber, a catalyst cabinet and or catalyst chamber and a control cabinet and or control interface. To reiterate, while the roasting apparatus and method described herein is discussed as applying to coffee beans, it is to be understood that the roasting apparatus and method as shown may be used for many other organic and non-organic items, such as nuts, chocolate, fruits, and wood chips.

Referring generally to FIGS. 1-9, a roasting chamber 20 may be the physical portion of the roasting apparatus 10 where coffee bean roasting occurs. As such, said roasting chamber 20 may be constructed to maintain a large amount of coffee beans and withstand high temperatures. In a preferred embodiment, said roasting chamber 20 may include a rotating drum 30, which tumbles the coffee beans as they are being heated. Said rotating drum 30 is primarily perforated throughout to allow airflow through said rotating drum 30 and contains stirring mechanisms to mix and loft the coffee beans while they roast. It should be understood that said roasting chamber 20 may be modified to include a fluid bed roaster (not shown) which raises the coffee beans up on a bed of hot air causing the beans to circulate inside the roasting chamber. It should also be understood that said roasting chamber 20 may be modified in the form of a continuous roaster cooperative with a belt, and a continuously fed drum roaster (also not shown). Said roasting chamber 20 further includes air and temperature probes to detect the temperature of the coffee beans and air inside the drum. The speed of said rotating drum 30 may be controlled to adjust the rotation of the drum as the density of the coffee beans change. Said rotating drum 30 may further include special fins to allow samples to be taken on smaller loads.

Heating elements may be located below the drum. The heating elements may be controlled by a control interface 50, and may further be augmented by heat in a catalyst chamber 40 as will be described in further detail below. In a preferred embodiment, the heating elements heat both the rotating drum 30 and the air inside the rotating drum 30. The heating elements are commercially available units known to those skilled in the art. The heating elements as disclosed may alternatively be powered by gas or other heating methods.

The present invention, roaster apparatus 10 is intended to be a roaster that can be operated indoors without the need of ventilation and that was also energy efficient. The present invention 10 addresses these issues with the use of catalytic technology. A low temperature metal substrate catalytic converter 60 is used to remove the volatile organic compounds (VOC) and other harmful toxins from the exhaust in order to prepare it for recirculation. It is contemplated, but not intended to be limiting, that the low temperature substrate catalytic converter 60 will be composed of metal, but it may be composed of other materials such as ceramic, composite or other materials. What is left after this process is clean air with coffee aroma that is safer to breathe.

The low temperature substrate catalytic converter 60 has an effective operating temperature of around 500° F., meaning that the air entering the low temperature substrate catalytic converter 60 must be at that temperature in order for proper filtration to occur. Depending on the stage of the roasting process, the airstream will usually require additional heating to reach 500° F. To solve this, the present invention 10 uses a small electric heater that is controlled by a thermocouple; this allows the present invention to heat the air to the exact required temperature, thus not wasting energy.

Once the exhaust has been cleaned, it is then ready for recirculation into the roasting chamber 20. The hot exhaust airstream is pumped directly into the back of the roaster where it is then used to roast the beans. This incoming air is generally over 450° F. so little extra heat is needed from the main roasting heater resulting in energy savings. If the incoming air is too hot or too cold, it can either be exhausted to the atmosphere to cool the roaster or additional heat may be added. All this is done automatically through the use of actuators that are controlled by thermocouples. In addition to increased efficiency, recirculation also results in improved flavor due to the aromatic compounds in the exhaust being able to “baste” the beans and retain more flavors.

The catalyst chamber 40, which contains the low temperature metal substrate catalytic converter 60 may be the physical portion of the roasting apparatus used to burn smoke and reduce exhaust emissions, as well as heat the air for recirculation to reduce energy consumption. In a preferred embodiment, the catalyst chamber 40 may be connected to the roasting chamber 20 through a plurality of conduits using a newly creative method of recirculating hot air through the rotating drum 30 by utilizing low temperature substrate catalytic converter 60 to remove smoke, tars and waste products from the air before returning the air to the roasting chamber 20 for reheating. The recirculation of air through the system to remove smoke and debris generates heat in the catalyst chamber 40, which can then be used to help heat the products being roasted. The new method utilized in the present invention 10 results in lower heating costs as compared with conventional roasting machines that depend on air outside of the system. While the catalyst chamber 40 is shown as connected to the roasting chamber 20 described herein, it is to be understood that the catalyst chamber 40 is not limited to any one type of chamber and may operate with a number of roasting chambers and control cabinets.

Furthermore, the present invention 10 may be constructed to use the oils, by-products and gases of the roasting process to create additional heat. The low temperature substrate catalytic converter 60 can also be used to clean the impurities produced from the roasting process so that the heat may be recirculated for a better and cleaner roast. One of the many advantages of utilizing the heat from the roasting process is the ability to lower the amount of oxygen as needed within the system. As such, oxygen intake into the system can be limited to that amount necessary for maintaining combustion within the catalyst chamber 40. This limitation and control of oxygen content results in a smoother tasting coffee.

In a preferred embodiment, the control interface 50 may include a touchscreen and function as a means for supplying power to the roasting apparatus 10 and housing a control program, such as a Programmable Logic Controller (PLC), which monitors and controls the roasting system in accordance with stored input values. While a single control interface 50 is preferred, the devices used to control the roasting system can be scattered on the roasting apparatus. Commonly, however, it has the form of a unified system so that it can be added as a unitized accessory. The roasting system may operate in a variety of basic modes: manual, programmed, and combinations thereof. In manual mode, the operator manually enters predetermined variables for particular components of the roasting apparatus 10, such as the heaters, fans and dampers. In programmed mode, a control program recalls stored input conditions such as fan motor speed, drum rotation speed, temperature and the like, and instructs the PLC what actions to take upon encountering particular input signals or conditions.

In a preferred embodiment, the present invention 10 allows roasting in a low oxygen atmosphere or in a modified gas atmosphere by allowing mixed air into roaster through air inlet at the back of machine. Oxygen may be adjusted in a variety of ways, explained in detail hereinafter, to allow better roasting of many products.

Moreover, the present invention 10 may be operated to provide self-cleaning. The roasting apparatus 10 may run in recirculation mode to act as a self-cleaning oven.

In a preferred embodiment of the present invention, the roasting apparatus 10 may operate as follows. It is understood that variations in the temperature, automation of devices, and systematic procedures disclosed herein are contemplated.

1. Roasting apparatus 10 may be heated to operating temperature. Normally equal to or less than 500° F. for the roasting chamber 20, or as needed, and approximately 500° F. for the low temperature substrate catalytic converter 60.

2. Product for roasting may be placed in green bean inlet 70. Operator starts process with manual or automated control by operating product charge handle 80 that also activates the charge hopper charge sensor. If roasting apparatus 10 is running an “automated profile program,” the program in control unit knows from the operator's input action that roasting has begun.

3. The control interface 50 may read thermocouples and compare to control program if in auto-mode or if in operator controlled manual mode, uses operator's input. The control interface 50 will allow heaters in recirculation tower and drum heaters to increase output to a preset amount of energy to allow them to reach temperatures that have been set. When input needs are achieved or operator/control program changes, system control allows for all operating needs for roasting to be automated or input manually though control.

4. Product may be tumbled in the rotating drum 30 by the drum motor and flights or arms in the drum and gear drive at a speed programmed by operator. Heat may be supplied to the rotating drum 30 by a drum heater. Airflow may be pulled through the system by a drum fan or cyclone fan. Air flows through pipe into a cyclone in the catalyst preheater. Heavy chaff and debris may be separated from airflow and deposited in chaff collector box, thermocouples in a catalyst preheater 90 also provides a temperature reading back to control unit to allow operator monitoring and to notify system and operator if an over temperature condition exists. Air exits cyclone and moves through the catalyst chamber 40, which includes the low temperature substrate catalytic converter 60. Heated air goes past incoming air thermocouple in the catalyst chamber 40 then into low temperature substrate catalytic converter 60. The low temperature substrate catalytic converter 60 burns off smoke and the cleaned air flows past the low temperature metal substrate catalytic converter 60 past another thermocouple and exits the catalyst chamber 40. The thermocouple may cooperate with the control unit to allow regulation of heater for the low temperature substrate catalytic converter 60 to hold set temperature desired by control program, or operator if in manual mode.

5. Airflow may enter exhaust reintroduction chamber 100. The reintroduction chamber 100 may have three different methods of directing airflow to the needs of the system, which are controlled by an actuated damper.
a. Air can exit the exhaust reintroduction chamber 100 through an outlet by opening to a desired setting actuated damper for exhaust air to reenter the roasting chamber 20. The amount of air exhausted is controlled to allow for lowest energy use.
b. Opening drum bypass damper recirculates system air to keep catalytic system heated. Also can be used by system for the removal of cooler smoke.
c. Opening return air damper actuator to open flow to a cooler tube 110 that allows the air to be cooled and vented outside of the present invention 10 or to be reintroduced into the roasting chamber 20 at the desired temperature.

6. In a preferred embodiment, normal operation for roasting may continue by following the use of (c) above; however, it is contemplated that normal operation may consist of any other method of airflow described herein, or combinations thereof.

7. Air may be moved by a pipe from recirculation tower into roasting chamber 20. Airflow may move through roaster drum heaters, thereby adding heat to the air and heating the rotating drum 30 by conductive, convective, or radiant heat methods, or combinations thereof. Air from the catalyst preheater 90 may flow through the roasting chamber 20, and thus, through the tumbling product mass. Airflow may then move past product and air thermocouples to provide temperature readings to the control interface 50 on the process.

8. By recirculating the air through a low temperature substrate catalytic converter 60, and providing two sources of heating, the present invention 10 has the ability to provide lower energy cost by making use of smoke as fuel for the low temperature substrate catalytic converter 60 in addition to recirculating the airflow. The present invention 10 also allows better control of roasting by allowing operator/control program to control air temperatures and rotating drum 30 (product) temperature with control over conductive heating provided by specially designed drum heating unit, which also helps remove smoke and other from undesirable by products from the process of roasting.

9. After product has reached desired temperature, and time desired in roasting process, and temperature and time that is set in control interface 50, product is dispensed by manually opening the bean discharge door manually or using drum door solenoid operated by the control interface 50 based on operator selections. Cooler stirrers are started along with cooler fan.

10. Cooling air from this system can be exhausted to the outside without smoke using a single catalytic system. Cooler smoke also helps keep the catalytic unit up to temperature between the batches of the product by providing smoke for catalyst to burn. A new batch of product is typically not at a high enough temperature to produce smoke during the first 5-6 minutes of roasting, smoke from the products being processed are used by a preferred embodiment of the present invention 10 to create additional heat, which in turn is used in roasting. Product is considered in this concept to have byproducts created in roasting that are used as fuel. The present invention 10 teaches a roasting system where recirculated heat can be cleaned to remove petrol chemical flavors, organic solids and tarry substances in the hot air can be removed before returning the heated air to the recirculated heating system, this will provide better tasting products than conventional roasting systems that just recirculate only.

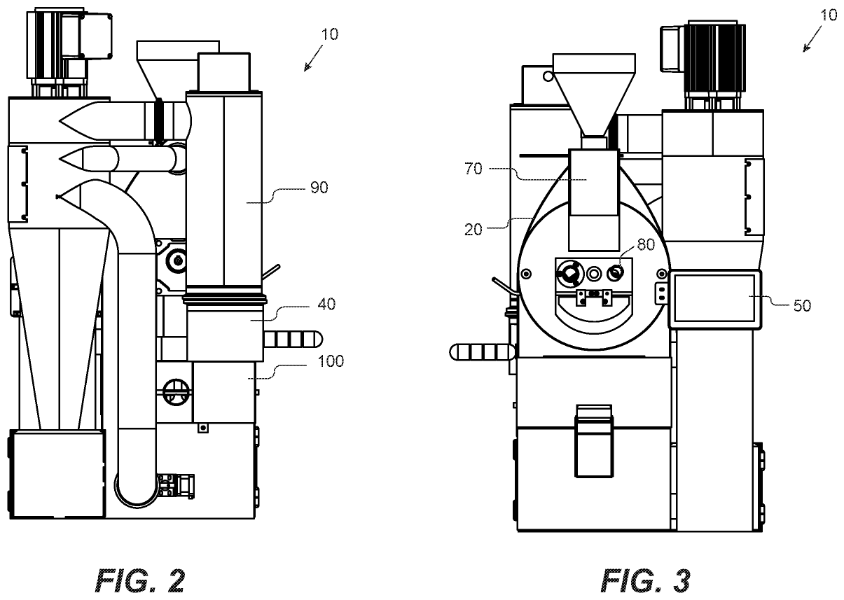

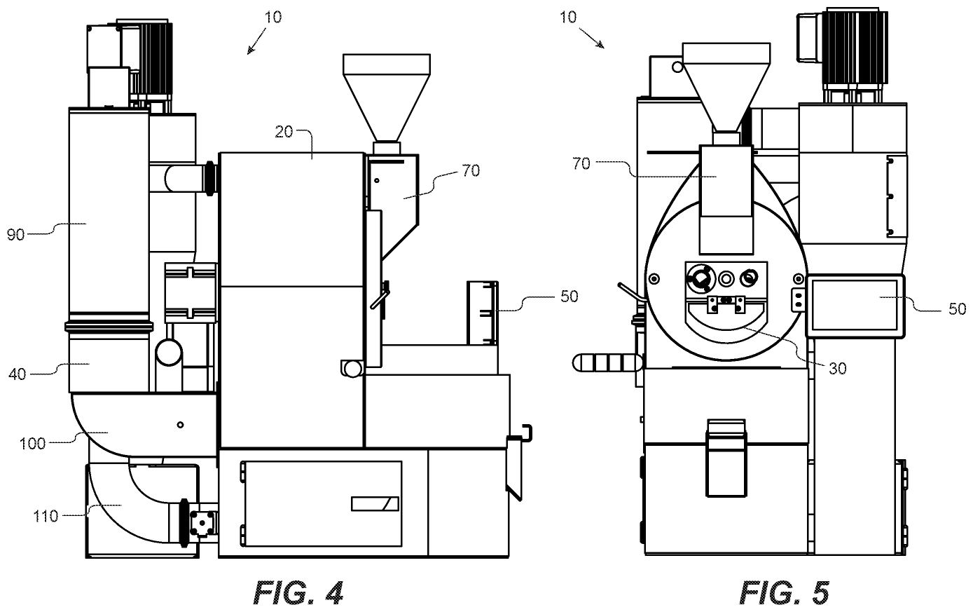

Turning now to FIGS. 2 and 4, the airflow of the present invention in a preferred embodiment may travel as follows:

1. The variable speed exhaust fan pulls heated air, smoke and chaff out of the roasting chamber 20 and into the catalyst preheater 90. This air goes into the catalyst preheater 90 where the chaff particulates fall out of the air stream into the collection bin at the bottom. The air then travels across the catalyst heating elements or other heating source. This heating source is used to bring the low temperature substrate catalytic converter 60 up to combustion temperatures. Once the PLC controls see the catalyst is firing, the low temperature substrate catalytic converter 60 heating elements are reduced in power. The smoke travels through the low temperature substrate catalytic converter 60 and is consumed. In fact, the smoke itself becomes a fuel source to support this combustion.

2. The heated and cleaned air is then routed to below the roasting chamber 20. This heated air for roasting is also supported by heating elements below the roasting chamber 20. The roasting process involves both convection heating with the hot air traveling through the bean mass as they tumble, and conduction heating by the radiant heat transmitted from the drum heating elements, through the metal drum and onto the bean surface.

3. The acidic smoke and chaff are removed from the roasting chamber 20 and returned to catalyst preheater 90 to repeat the cycle.

4. When the beans are nearing the desired finishing temperature, no more additional heat may be required. The system does two things: (1) It reduces the heat from the heating elements under the rotating drum 30, and (2) it bypasses the cleaned, heated air away from returning to the rotating drum 30 and back into the exhaust air stream.

5. To insure optimum combustion at the low temperature substrate catalytic converter 60, some oxygen must be introduced into the air stream. Otherwise, the continuous circulation of the air within the process depletes the oxygen content during the combustion by the low temperature substrate catalytic converter 60. Air is also introduced into the stream when the roasting process is over and the unit is in the cool down mode.

6. Once the roasting is finished and the majority of the smoke is consumed by the low temperature substrate catalytic converter 60, the remaining hot air is vented out of the present invention 10 and cool air is drawn into the present invention 10 to bring its internal temperature down to the shutdown set point.

Invention 10 may be a method for roasting coffee beans comprising the steps: roasting said coffee beans in a roasting chamber at a temperature equal to or less than 500° F.; removing heated air, smoke, and chaff out of said roasting chamber via an exhaust fan; sending said heated air, said smoke, and said chaff into a catalyst preheater wherein said chaff falls into a collection bin and said heated air is heated or cooled to a predetermined temperature; sending said heated air and said smoke across a heating element to bring said catalytic converter up to a temperature for combustion; detecting said catalytic converter firing and lowering the temperature of a catalytic converter as desired; consuming said smoke by traveling through said catalytic converter; detecting the temperature of said heated air and lowering or raising said heated air as desired; and routing said heated air back to said roasting chamber.

While the invention 10 has been described with a certain degree of particularity, it is manifest that many changes may be made in the details of the construction and the arrangements of the components and method of implementation without departing from the spirit and scope of this disclosure. It is understood that the invention 10 is not limited to the embodiments and methodologies set forth herein for purposes of exemplification, but is to be limited only by the scope of the explanations of the invention 10, including the full range of equivalency to which each element thereof is entitled. Changes may be made in the combinations, operations, and arrangements of the various parts and elements described herein without departing from the spirit and scope of the invention 10.

What is claimed is:

1. A method for roasting coffee beans comprising the steps:
roasting said coffee beans in a roasting chamber at a temperature equal to or less than 500° F.;
removing heated air, smoke, and chaff out of said roasting chamber;
sending said heated air, said smoke, and said chaff into a catalyst preheater wherein said chaff falls into a collection bin and said heated air is heated or cooled to a predetermined temperature;
sending said heated air and said smoke across a heating element to bring said catalytic converter up to a temperature for combustion;
detecting said catalytic converter firing and lowering the temperature of a catalytic converter as desired;
consuming said smoke by traveling through said catalytic converter;
detecting the temperature of said heated air and lowering or raising said heated air as desired; and
routing said heated air back to said roasting chamber.
